(19) United States
(12) Patent Application Publication
(10) Pub. No.: US 2004/0240669 A1
(43) Pub. Date: Dec. 2, 2004

(54) Securing neighbor discovery using address based keys

(76) Inventors: James Kempf, Mountain View, CA (US); Craig Gentry, Mountain View, CA (US); Alice Silverberg, Columbus, OH (US)

Correspondence Address: BRINKS HOFER GILSON & LIONE, P.O. BOX 10395, CHICAGO, IL, 60610, US

(21) Appl. No.: 10/364,686

(22) Filed: Feb. 11, 2003

Related U.S. Application Data
(60) Provisional application No. 60/358,286, filed on Feb. 19, 2002.

(51) Int. Cl. H04L 9/00

(52) U.S. Cl. 380/277; 713/150; 380/44

(57) ABSTRACT

A system and method are disclosed for securing neighbor discovery in IP networking system. A public key is generated using an IP address value of the host and routed prefix for the router. Thereafter, an Identity based Private Key Generator (IPKG) generates a private key using public cryptographic parameters, that corresponds to the host's or router's public key. Thereafter, neighbor discovery is authenticated with the public/private pair key and the public parameters.

### RELATED APPLICATIONS

This application claims priority to the earlier filed provisional U.S. patent application serial No. 60/358,286, filed Feb. 19, 2002, entitled “Securing IPV6 Neighbor Discovery Using Address Based Keys (ABK),” which is incorporated by reference herein.

### BACKGROUND

The Internet Protocol Version 6 (IPv6) Neighbor Discovery protocol described in Internet standards Request for Comment (RFC) 2461 accommodates last hop network access for IPv6 network nodes. A last hop is the link between the host and the first/last router before entering the network. The protocol allows a IP hosts joining a link to discover a router, and for nodes on the link, including the router, to discover the link layer address of an IP node on the link to which IP traffic is delivered. Disruption of the protocol can have a serious impact on the ability of nodes to send and receive IP traffic.

Yet, security on the protocol is weak. As stated in the RFC, the protocol contains no mechanism to determine which neighbors are authorized to send a particular type of message. Any neighbor, presumably even in the presence of authentication, can send Router Advertisement messages thereby being able to cause denial of network service. Furthermore, any neighbor can send proxy Neighbor Advertisements as well as unsolicited Neighbor Advertisements as a potential denial of service attack.

Multiple threats can occur to IPv6 Neighbor Discovery on multi-access links. These threats can occur for both wired and wireless public multi-access links. The threats are a particular problem for wireless links. Even private multi-access links over shared access, as opposed to switched, media with link level authentication mechanisms such as the 802.1x Port Based Access Control, 2001 IEEE Standard for Local and Metropolitan Area Networks, are subject to disruption if an authenticated host decides to deceive the system.

RFC 2461 recommends using IP Security Authentication Header (IPsec AH) authentication if a security association exists, but this is a complex solution and is unlikely to be widely applicable to public access networks. In particular, a roaming host in a foreign public access network is unlikely to have a security association with the local access router or with other hosts on the same link. Indeed, most of the nodes on the same link may not even have the same home Internet Service Provider (ISP) as the roaming node.

### BRIEF SUMMARY

A system and method are disclosed for securing neighbor discovery in IP networking system. A public key is generated using an IP address value of the host. Thereafter, an Identity based Private Key Generator (IPKG) generates a private key using public cryptographic parameters, that corresponds to the host's public key. Thereafter, neighbor discovery is authenticated with the private key.

### BRIEF DESCRIPTION OF THE DRAWINGS

FIG. 1 illustrates an exemplary Internet Protocol network.

FIG. 2 illustrates an exemplary format of the ABK Digital Signature option.

FIG. 3 illustrates an exemplary format of the ABK Algorithm option.

### DETAILED DESCRIPTION

Presently preferred embodiments of a mechanism for securing telecommunication Neighbor Discovery are described herein with reference to the drawings, wherein like components are identified with the same references. The Neighbor Discovery security mechanism is described for optimizing Neighbor Discover using cryptographic techniques. The security mechanism includes the use of Address Based Keys (ABKs) that use identity based encryption from the Weil paring and cryptosystems based on pairing for digital signature calculation. The descriptions contained herein are intended to be exemplary in nature and are not intended to limit the scope of the invention.

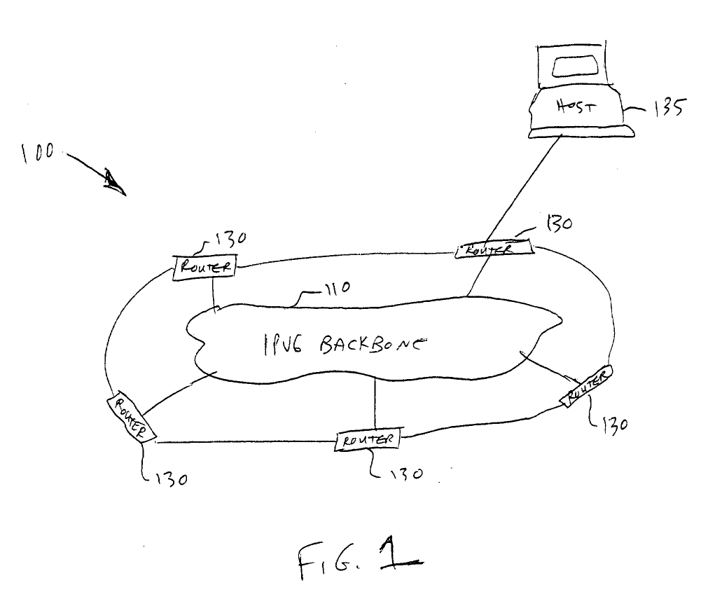

FIG. 1 illustrates an exemplary Internet protocol (IP) network 100. The IP network 100 includes an IPv6 or other network 110. Data is communicated within and over the network in accordance with Internet protocol Version 6 (IPv6), specified as IETF RFC 2460, which is incorporated herein by reference. Built on the IPv6 network 110 is a collection of Routers 130. The Routers 130, in accordance with the conventional Internet addressing and routing protocols, route packets of data between source and destination nodes connected to the network 100. The Routers 130 are themselves nodes and have unique IP addresses for communication over the network 100. The Routers 130 are able to interface with Hosts 135. The Hosts 135 may include different kinds of devices, such as phones, computers and personal digital assistants (PDA's). Information can be communicated via landlines, wireless communications, cellular communication, satellites, and the like.

An easy to implement protocol that secures IPv6 Neighbor Discovery is described. The protocol allows IP hosts to verify that a Host 135 advertising routing for a local subnet prefix is allowed to route the prefix, and that information provided in a Neighbor Discovery message is authentic. No additional telecommunications infrastructure is required than is currently needed for public access IP networks. The protocol utilizes output from identity based cryptosystems. A publicly known identifier, e.g., parts of a node's IP address, can serve as a public key. Address Based Keys (ABKs) can be used to generate public/private key pairs from the IP address.

ABKs can be used to generate the Host's 135 public and private key from the Host's 135 IPv6 subnet prefix or interface identifier. Identity based cryptosystems allow a publicly known identifier, such as the IPv6 address, to be used as a public key for authentication, key agreement, and encryption. An identity based Private Key Generator (IPKG) executes an identity based cryptographic algorithm to generate a private key when presented with the public identifier that will act as the public key. The IPKG algorithm can execute from the home network or foreign network authentication server. Public cryptographic parameters include a collection of publicly known parameters formed from chosen constants. The IPKG uses a collection of publicly known parameters and a public key for the Host derived from the Host's IP address to generate the Host's private key. The Host 135 involved in securing or encrypting a message use the public/private key pair to perform cryptographic operations.

Identity based cryptosystems include a collection of cryptographic techniques that allow a publicly known identifier, such as the email address or, as with the present application the IP address of the Host 135, to function as the public key part of a public/private key pair. The cryptosystem performs digital signature calculations, key agreement and encryption. Elliptic curve (EC) algorithms operate well for identity based keys because they operate with small key sizes, are computationally efficient on small hosts, such as small wireless devices, and may generate smaller signatures. Other, non-EC algorithms can also be used for identity based digital signature calculations, but may not operate as efficiently as the EC algorithm.

Identity based cryptosystems operate with a publicly known identifier being submitted to the IPKG. The publicly known identifier can include, for example, the 64 bit subnet prefix or the unique 62 bit interface identifier of an IPv6 address. The IPKG uses a particular algorithm to generate the private key and returns the private key to the system, e.g., the Host 135. The connection between the IPKG and the Host 135 should be private, e.g. encrypted, or the key should be returned in another secure manner. The public and private key can then be used for authentication and encryption, as in typical cryptosystems.

Identity based cryptographic algorithms utilize a secret key known only to the IPKG to generate the public cryptographic parameters used by clients of the public and private key, such as the Host 135. As a result, unlike the Diffie-Hellman algorithm, the public cryptographic parameters are not fixed, and therefore not preprogrammed into the clients. The secret key could expire or become compromised, in which case, the public cryptographic parameters are preferably updated.

Digital signatures can be calculated using the following algorithm:

sig=SIGN(hash(contents),IPrK,Params)

where:

sig—The digital signature.

SIGN—The identity based digital signature algorithm used to calculate the signature.

hash—The HMAC-SHA1 one-way hash algorithm.

IPrK—The Identity based Private Key.

Params—The public cryptographic parameters.

contents—The message contents to be signed.

The digital signature can be verified using the following algorithm:

IPuK=IBC-HASH(ID)

valid=VERIFY(hash(contents),sig,IPuK)

where:

IBC-HASH—A hash function specific to the identity based algorithm that generates the public key from the public identifier.

ID—The publicly known identifier used to generate the key.

IPuK—The Identity based Public Key.

sig—The digital signature.

VERIFY—The identity based public key algorithm used to verify the key.

Params—The public cryptographic parameters.

valid—1 if the signature is verified, 0 if not.

The Host 135 and last hop Router 130 participating in Neighbor Discovery are each separately configured with an identity based private key and with cryptographic parameters before securing the messaging. When the ISP or network owner establishes last hop routers, the routers are configured with the 64 bit subnet prefix or other advertised prefixes. In addition, the ISP uses the IPKG to generate a private key for the prefix. The Router 130 uses the private key to generate digital signatures on Router Advertisements. The private key and the public cryptographic parameters are installed on the Router 130 through a secure channel. Examples of possible secure channels include configuration by a network administrator, installation via an NAS-based AAA network capable of secure key distribution, and installation via a secure message exchange to a server with which the Router 130 has an IPSec security association.

The Hosts 135 utilize an identity based private key associated with the 62 bit interface identifier, for example, the bottom 62 bits (64 bits minus the “u” and “g” bit, in the IPv6 address, and the public cryptographic parameters. The Host 135 can be configured dynamically, such as when the Host 135 is initially authenticated and authorized for network access through a secure connection with the NAS. Moreover, the Host 135 can be configured statically, such as when the home ISP of the Host initially 135 assigns the interface identifier.

Most public access networks currently require the Host 135 to undergo a secure authentication and authorization exchange through a NAS prior to being able to use the network. Since this exchange is typically performed at Layer 2 before any IP signaling, the exchange can be accomplished prior to any Neighbor Discovery signaling. The Host 135 includes an interface identifier in a message to the NAS. The NAS sends the interface identifier to the IPKG, where the private key is generated. The private key and public cryptographic parameters are then securely transferred back to the Host 135 where they are installed. The secured transfer can be accomplished using TLS over EAP over PPP or some other Layer 2 protocol. The Hosts 135 on the local link and the last hop router then use the public cryptographic parameters and the private key for the foreign network to secure IPv6 Neighbor Discovery signaling.

Some public access networks may not perform secure Layer 2 authentication and authorization prior to allowing the Host 135 to perform Neighbor Discovery. To accommodate these kinds of networks, Hosts 135 are configured with public cryptographic parameters and a private key by their home ISPs or network operators. The messaging for securing Neighbor Discovery includes an identifier based on the realm portion, typically the DNS domain name, e.g. “docomolabs-usa.com”, of the Network Access Identifier (NAI). This identifier allows the Hosts 135 and Routers 130 on the local link to authenticate the signaling of guest hosts. Roaming consortia co-ordinate the IPKGs. Roaming consortia are groups of ISPs that have a business relationship to allow clients to roam among them. The roaming consortia co-ordinate IPKGs as they co-ordinate the exchange of other information needed to establish authentication, authorization and accounting for customers. The various ISPs in the consortium can accommodate guest hosts. If static configuration is used, the cryptographic parameters for both Router 130 and the Host 135 authentication are installed, since they need not be identical.

The following protocol can be used to secure IPv6 router advertisements. A router advertisement sent by a router configured with a 64 bit prefix key contains a digital signature. The signature signs the relevant fields within the message, including ICMP message options, if any. The ICMP message options include:

Current hop limit (chl)

Flags (fl)

Router lifetime (rol)

Reachable lifetime (rel)

Retransmit timer (rtt)

Source link-layer address option (if there) (sllao)

MTU option (if there) (mtuo)

Prefix option (pro)

The ABK Digital Signature option without signature (idso)

Any other options ( . . . )

In the signing algorithm, the input into the HMAC-SHA1 algorithm which generates a message authentication code as a one-way hash), includes the following:

contents=(chl,fl,rol,rel,rtt,sllao,mtuo,pro,dso, . . . )

IPrK in the signing algorithm is the router's 64 bit subnet prefix.

The digital signature is included in an ABK Digital Signature option with the signature, algorithm, and realm identifier. An ICMP option (Internet Control Message Protocol, the protocol used to exchange control messages on the Internet) may be used instead of IPSec AH (An Internet Protocol Security Authentication Header, used to establish authentication on a packet). Neighbor Discovery options that are not recognized by the Host 135 are ignored. A Host 135 that is unable to verify the signature but is able to use an unsecured Router Advertisement can ignore the option as a consequence of normal Neighbor Discovery processing, instead of having the Router Advertisement rejected by IPSec processing.

The Router Advertisement includes a Prefix option with the prefix for which the key was assigned. If the Router 130 routes more than a single prefix, the router advertises them using separate Router Advertisements. If the Router 130 supports multiple identity based algorithms, the Router 130 can include multiple ABK Digital Signature options with signatures calculated by the various algorithms such as the Boneh-Franklin algorithm, up to the path MTU (the maximum size of a packet that can be routed before segmentation is required).

An IPv6 host, such as Host 135, receiving a Router Advertisement with an ABK Digital Signature option verifies that the advertising node is authorized to send the advertisement. If the Router Advertisement does not contain a routing prefix option, or if the Router Advertisement contains more than one routing prefix option, the Host 135 discards the Router Advertisement, unless the Host 135 can risk an unsecured Router Advertisement. If the Host 135 does not support one of the algorithms used for signing the message, the Host 135 preferably discards the Router Advertisement, unless the Host 135 can use an unsecured Router Advertisement.

The Host 135 locates the single routing prefix option and extracts the subnet prefix which the sending node, e.g., Router 130 is attempting to route. The Host 135 then uses the verification algorithm to verify the digital signature using the same value for contents as in the calculation of the Router Advertisement signature. In this calculation, the public key is generated using the subnet prefix in the Prefix option. The identity based algorithm and router public cryptographic parameters depend on the algorithm and realm identifier in the ABK Digital Signature option.

A lengthy negotiation process is preferably not used for determining which identity based algorithm to use. Since algorithms change over time, the Host 135 can indicate in a Router Solicitation which algorithms to support. If the Router 130 cannot provide an authenticator for any of the algorithms, the Host 135 can return an unauthenticated Router Advertisement and proceed if acceptable. If no authentication is provided, the Host 135 can use an Identity Algorithm.

For multicast Router Advertisements, the Router 130 can include ABK Digital Signature options for each supported algorithm, up to the path MTU. Alternatively, the Host 135 can be required to solicit the Router Advertisement and inform the Router 130 what algorithms it supports in an ABK Algorithm option. A similar procedure can be used for securing IPv6 Neighbor Discovery messages. A Neighbor Advertisement sent in reply to a Neighbor Discovery message contains a digital signature calculated with the private key generated from the 62 bit interface identifier and the host public cryptographic parameters. The signature can be calculated using the relevant fields within the message, including all options, if any. These fields include:

Flags (flg)

Target Address (addr)

Target Link Layer Address option (l2addr)

The ABK Digital Signature option itself, without signature (idso)

The Target Link Layer Address option is preferably included.

In the signing algorithm, the input into the hash algorithm can be as follows:

contents=(flg,addr,l2addr)

IPrK is the interface identifier private key.

The digital signature is included in an ABK Digital Signature option with the signature, algorithm, and realm identifier. Again, an ICMP option can be used instead of IPSec AH because Neighbor Discovery options that are not recognized by a Host 135 can be ignored. An IPv6 host receiving a Neighbor Advertisement with an ABK Digital Signature option verifies that the advertising Host is authorized to send the advertisement. If the receiving Host 135 does not support one of the algorithms used for encrypting the signature, it should discard the Neighbor Advertisement, unless the Host 135 can risk using an unsecured Neighbor Advertisement.

The Host 135 uses the verification algorithm in to verify the digital signature using the value for contents as in the calculation of the signature for the Neighbor Advertisement. In this calculation, the ID includes the 62 bit interface identifier of the Host 135. The identity based algorithm and host public cryptographic parameters depend on the algorithm and realm identifier in the ABK Digital Signature option.

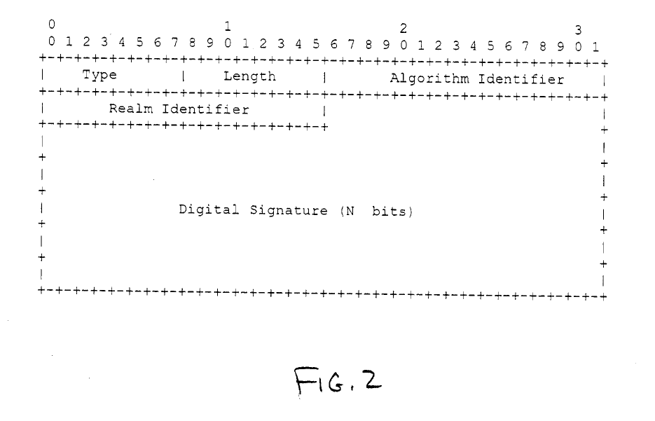

FIG. 2 illustrates an exemplary format of the ABK Digital Signature option. A node, e.g., Host 135, sending a Neighbor Solicitation message can indicate what algorithms the node can accept, by including an ABK Algorithm option in the message. The ABK Digital Signature option contains a digital signature calculated using address based private key, and is preferably the last option in the list. The type field includes an eight bit identifier for the option type, for example, assigned by Internet Assigned Numbers Authority IANA. The length field includes an eight bit unsigned integer giving the option length, including type and length fields, in units of eight octets, e.g., eight bites. The algorithm identifier field includes a sixteen bit nonzero algorithm identifier, assigned by IANA, indicating the identity based algorithm used to sign the message. The realm identifier includes either the sixteen bit nonzero HMAC-SHA1 hash, or other way of obtaining a unique identifier for the host and home network, of the realm part of the network access identifier (NAI) which is used to identify the host and the host's home network. Alternatively, the realm identifier includes a zero value to indicate that the current network's IPKG and public cryptographic parameters should be used. The digital signature filed includes an N bit field containing the digital signature. The field is zero aligned to the nearest eight byte boundary, i.e., if the size is less than an even number of octets, the remaining fields are filled with zeros. Different bit amounts may be used, the number of bits depends on the identity based algorithm and use of the system.

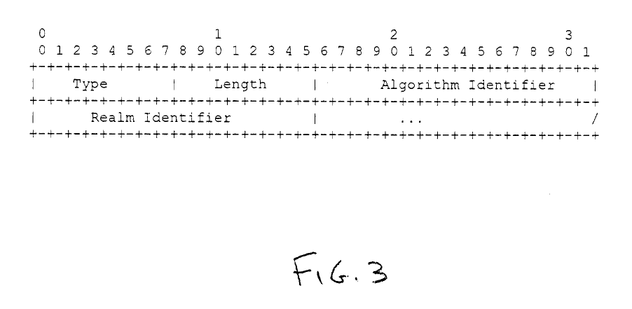

FIG. 3 illustrates an exemplary format of the ABK Algorithm option. The ABK Algorithm option allows a host to indicate which identity based keying algorithms it supports for particular realms when requesting a Router Advertisement or Neighbor Advertisement. The ABK Algorithm option can include a type field, e.g. an eight bit identifier for the option type, assigned by IANA. A length can include an eight bit unsigned integer giving the option length, including type and length fields, in units of eight octets. An algorithm identifier field includes a sixteen bit nonzero algorithm identifier, assigned by IANA, indicating the identity based algorithm used to sign the message. A realm identifier field can include either the sixteen bit nonzero number, e.g., a number calculated using HMAC-SHA1 hash algorithm, of the realm part of the NAI, or a zero value to indicate use of the current network's algorithm. The remaining optional field can contain algorithm identifier-realm identifier pairs, in order of preference that the Host 135 supports. The option can include a zero value padded to multiples of eight bytes.

ABKs hash the interface identification or subnet prefix to form the public key. The ABKs require that the Host 135 be provided with a private key by the entity that assigns the address of the Host 135. ABKs require configuration with the public cryptographic parameters because the IPKG uses a shared secret to perform the private key generation, and the shared secret might expire or be compromised.

An address used to perform encryption with an ABK is not arbitrarily assigned using Dynamic Host Configuration Protocol DHCP, or other protocol used to configure hosts with IP addresses. An address used for ABK encryption can be constructed using an IPv6 Stateless Address Autoconfiguration when the Host performing the Stateless Address Autoconfiguration includes an ABK interface identification and private key for the suffix 64 bits of the address and no duplicate is detected. The mechanism described to secure Neighbor Discovery could also be used to secure Stateless Address Autoconfiguration.

With some identity based algorithms, the IPKG maintains a copy of the public and private key, the “key escrow” property. Consequently, the address assignor's IPKG stores the private keys for every address, and can potentially access authenticated or encrypted traffic. However, the ABK is preferably only used to secure IPv6 signaling traffic and not sensitive private data. Both the ISP or network operator and the legitimate client/user have an interest in efficient operation of the network. In the way that ISPs are used to protect credit card numbers, the ISP can guard ABK information.

If a group of ISPs in a roaming consortium choose to support ABKs, they can co-ordinate to share a master key. There are techniques that allow secure generation of ABKs in such circumstances, for example, HIDE Hierarchical Identity based encryption, but generally ISPs in a roaming consortium trust each other for billing and settlement. Business procedures and computational mechanisms for guarding privileged information are likely to be in place. A collection of ISPs that share a contract for IPKGs allows customers to securely use networks, but other networks may either receive insecure or no service, as is currently the case with roaming.

Identity-based schemes require standard cryptography components such as RSA and Elliptic Curve Cryptography (ECC), making it possible to implement them with known and widely distributed cryptographic libraries. A wide variety of identity based cryptoalgorithms could be used for ABKs such as D. Boneh and M. Franklin, “Identity based encryption from the Weil pairing,” suitable for encryption, and R. Sakai, K. Ohgishi, and M. Kasahara, “Cryptosystems based on pairing,” suitable for digital signature calculation.

While the invention has been described above by reference to various embodiments, it will be understood that many changes and modifications can be made without departing from the scope of the invention. It is therefore intended that the foregoing detailed description be understood as an illustration of the presently preferred embodiments of the invention, and not as a definition of the invention. It is only the following claims, including all equivalents, which are intended to define the scope of this invention.

1. A method of securing neighbor discovery in a telecommunications system, the method comprising:
generating a public key using a Internet Protocol address value of the host;
generating a private key from the public key; and
utilizing the public key and private key to secure neighbor discovery.

2. The method of claim 1 wherein a host generates the public key.

3. The method of claim 1 wherein a host receives a private key.

4. The method of claim 3 wherein the private key is received via a secure channel.

5. The method of claim 3 wherein the private key is generated by an identity based private key generator.

6. The method of claim 1 wherein a router generates the public key.

7. The method of claim 1 wherein a router receives a private key via a secure channel generated by an identity based private key generator

8. The method of claim 1 wherein neighbor discovery is ensured with a public key private key pair and public cryptographic parameters.

9. The method of claim 8 wherein the cryptographic parameters are received from an identity based private key generator.

10. A system for securing neighbor discovery in a telecommunications system, comprising:
a host connected with a router wherein a public key is generated using a Internet Protocol address value of the host, a private key is generated from the public key, and the public key and private key are used to secure neighbor discovery.

11. The system of claim 10 wherein a host generates the public key.

12. The system of claim 10 wherein a host receives a private key.

13. The system of claim 12 wherein the private key is received via a secure channel.

14. The system of claim 12 wherein the private key is generated by an identity based private key generator.

15. The system of claim 10 wherein a router generates the public key.

16. The system of claim 10 wherein a router receives a private key via a secure channel generated by an identity based private key generator

17. The system of claim 10 wherein neighbor discovery is ensured with a public key private key pair and public cryptographic parameters.

18. The system of claim 17 wherein the cryptographic parameters are received from an identity based private key generator.

19. A host for use in a telecommunications system, comprising:
an interface capable of connecting the host with a router wherein a public key is generated using a Internet Protocol address value of the host, a private key is generated from the public key, and the public key and private key are used to secure neighbor discovery.

20. The host of claim 19 wherein the host is adapted to generate the public key.

21. The host of claim 19 wherein the host is adapted to receive a private key.

22. The host of claim 21 wherein the private key is received via a secure channel.

23. The host of claim 21 wherein the private key is generated by an identity based private key generator.

24. The host of claim 19 wherein the router generates the public key.

25. The host of claim 19 wherein the router is adapted to receive a private key via a secure channel generated by an identity based private key generator

26. The host of claim 19 wherein neighbor discovery is ensured with a public key private key pair and public cryptographic parameters.

27. The host of claim 26 wherein the cryptographic parameters are received from an identity based private key generator.
